(19) United States
(12) Patent Application Publication
(10) Pub. No.: US 2026/0357937 A1
(43) Pub. Date: Nov. 12, 2026

(54) CONNECTOR FOR CONNECTING A FIRST FLUID LINE TO A SECOND FLUID LINE

(71) Applicant: Henn GmbH & Co KG., Dornbirn (AT)

(72) Inventor: Marvin HOPPE, Dornbirn (AT)

(73) Assignee: Henn GmbH & Co KG., Dornbirn (AT)

(21) Appl. No.: 19/515,840

(22) PCT Filed: Sep. 3, 2024
(86) PCT No.: PCT/AT2024/060331

§ 371 Date: Mar. 3, 2026

(30) Foreign Application Priority Data
Sep. 4, 2023 (AT) A50700/2023

(51) Int. Cl. F16L 37/133; F16L 37/098; F16L 37/138

(52) U.S. Cl. CPC F16L 37/133; F16L 37/0982; F16L 37/138

(57) ABSTRACT

A connector has an outer sleeve and an inner sleeve having two locking jaws in a standby position in an outer sleeve initial position and a locked position in an outer sleeve interlocking position. The outer sleeve includes a snap-in element having a first snap-in section having an actuating projection and is received between two adjacent jaws and two second snap-in sections connected thereto that each have a snap-in projection with a snap-in end face facing a first inner sleeve end. Each jaw includes an actuating section including first and second abutment end faces. The actuating projection is displaceable radially outward so that the snap-in projections are releasable from the second abutment end faces to the first abutment end faces.

The invention relates to a plug-in connector for connecting a first fluid line to a second fluid line, wherein the plug-in connector comprises an inner sleeve with an open first inner sleeve end and an open second inner sleeve end connected to the first inner sleeve end, and comprises an outer sleeve surrounding the inner sleeve, which outer sleeve is movable relative to the inner sleeve between an initial position and an interlocking position, wherein the inner sleeve has a first connecting section, in the region of the first inner sleeve end, for connecting the first fluid line and has a second connecting section, in the region of the second inner sleeve end, for connecting the second fluid line. The invention also relates to a plug-in connector assembly and a usage of the plug-in connector.

Generic plug-in connectors are used in a wide variety of industrial regions to connect two fluid lines, preferably in a sealed manner. This usually takes place as part of the assembly process for a specific fluid-carrying product. Depending on the specific region of application and the fluid used, the fluid lines may be essentially rigid pipes or flexible hoses. However, a fluid line may also be integrated into a component. The fluids used may be gaseous or liquid media. Gaseous media may include, for example, (compressed) air or certain process gases. For example, water, lubricating oil, coolant, refrigerant, etc. is used as liquid media.

During the assembly process of a product, it may be necessary, for example, to connect a first fluid line or a fluid port of a component to be assembled to a corresponding fluid line or a corresponding fluid port of the existing product. Due to increasingly efficient production processes, the throughput time in the assembly process is also generally shortened. As a result of this, less and less time is available for the individual assembly steps. In addition to high reliability, it is therefore also desirable to connect the fluid lines quickly using the plug-in connector. As a rule, one side of the plug-in connector is connected directly to one of the two fluid lines and the other fluid line is first connected to a plug-in sleeve. To connect the two lines, the plug-in sleeve is finally coupled with the plug-in connector, usually in a releasable manner.

Generic connectors are known, for example, from EP 1 955 413 B1, EP 3 286 477 B1, and EP 3 379 129 B1.

The object of the present invention was to overcome the disadvantages of the prior art and to provide a plug-in connector that is easy to use and enables reliable and quick connection and disconnection of a fluid line.

This object is achieved by a plug-in connector according to claim 1. The plug-in connector according to the invention enables simple and ergonomic operation and allows multiple use. The plug-in connector is constructed in a relatively simple manner and ensures a high level of connection security thanks to its clearly recognizable states. In particular, the outer sleeve may only be moved into the interlocking position when the connection has been made correctly. A further advantage is that the first fluid line may be rotated when connected. The spreading mechanism of the locking jaws enables easy insertion and, in particular, easy detachment of the first fluid line with low insertion forces.

Preferably, the outer sleeve is movable in a longitudinal direction along the inner sleeve between the initial position and the interlocking position. This simplifies handling because no twisting of the outer sleeve is necessary.

Preferably, the locking jaws each have a free first jaw end, at which the first inner sleeve end is located, and an opposite second jaw end, which is connected to the inner sleeve, wherein the first jaw ends are movable in a radial direction relative to the second jaw ends between the standby position and the locked position, wherein the locking jaws each have a circumferential groove on an inner circumferential surface, which circumferential groove is arranged between the first jaw end and the second jaw end, wherein the circumferential grooves are formed to receive the retaining section of the first fluid line in a form-fitting manner in the locked position of the locking jaws. The integral structure simplifies manufacturing, and the retaining groove enables improved retention of the fluid line.

Preferably, the at least one snap-in element is arranged on an inner circumferential surface of the outer sleeve and has a free first snap-in element end facing the first inner sleeve end and an opposite second snap-in element end connected to the inner circumferential surface of the outer sleeve, wherein the first snap-in element end is movable in the radial direction relative to the second snap-in element end. This allows the outer sleeve to be formed in one piece, which may simplify manufacturing.

Preferably, the actuating projection at the first snap-in element end comprises a first actuating chamfer which is configured to interact with the retaining section of the first fluid line to displace the actuating projection when the first fluid line is inserted into the first inner sleeve end and/or comprises a second actuating chamfer on a side facing the second snap-in element end, which second actuating chamfer is configured to interact with the retaining section of the first fluid line to displace the actuating projection when the first fluid line is removed from the first inner sleeve end. This simplifies connecting and releasing of the fluid line.

It is advantageous if the first snap-in section is arranged centrally between the two second snap-in sections in the circumferential direction and comprises the first snap-in element end, that the actuating projection is provided on the first snap-in section in the region of the first snap-in element end, and that the snap-in projections of the second snap-in sections are each arranged between the actuating projection and the second snap-in element end in the longitudinal direction. The design is structurally simple and has proven itself in practical tests.

Preferably, in the initial position of the outer sleeve, the first inner sleeve end of the inner sleeve protrudes beyond a first outer sleeve end of the outer sleeve. This allows the locking jaws to be spread relatively far apart in the radial direction, which facilitates the insertion of the fluid line.

Preferably, at least three, particularly preferably at least four locking jaws are provided and/or at least two snap-in elements are provided. A higher number of locking jaws and snap-in elements simplifies connecting and releasing and improves the hold.

Preferably, the actuating sections of the locking jaws each comprise a sliding surface which connects the first stop end face to the second stop end face, wherein the sliding surface comprises a restraining surface inclined in the direction of the first jaw end. The restraining surface prevents unwanted release of the locking. The release only occurs when a sufficiently large actuating force is applied.

Preferably, the inner sleeve is made of plastic, wherein the locking jaws are integrally formed with the inner sleeve and wherein the first jaw ends are elastically bendable between the locked position and the standby position. Alternatively or additionally, the outer sleeve may be made of plastic, wherein the at least one snap-in element is integrally formed with the outer sleeve and wherein the first snap-in element end is elastically bendable in the radial direction relative to the second snap-in element end. This allows the plug-in connector to be manufactured simply and cost-efficiently and enables flexible design.

Preferably, the outer sleeve is moveable relative to the inner sleeve from the interlocking position via the initial position into a release position, wherein the first snap-in section of the at least one snap-in element comprises a first wedge surface on each of its sides opposite each other in the circumferential direction, wherein the first wedge surfaces converge towards the second inner sleeve end, wherein the locking jaws between which the first snap-in section is received, each comprise a second wedge surface on their sides facing each other in the circumferential direction, wherein the second wedge surfaces converge towards the second inner sleeve end, and wherein the first wedge surfaces are configured to interact with the second wedge surfaces during the movement of the outer sleeve from the initial position into the release position in order to spread the locking jaws from the standby position into a release position in which the locking of the first fluid line, in particular the reception in a form-fitting manner of the retaining section in the circumferential grooves, is completely releasable. This facilitates handling of the plug-in connector when releasing the fluid line, as the retaining section of the fluid line may be removed more easily from the circumferential grooves.

Alternatively or additionally, it is advantageous that the outer sleeve is moveable relative to the inner sleeve from the interlocking position via the initial position into a release position, that at least one spreading projection is provided on an inner circumferential surface of the outer sleeve, which spreading projection is received in the circumferential direction between two adjacent locking jaws, that the spreading projection comprises a first wedge surface on each of its sides opposite each other in the circumferential direction, wherein the first wedge surfaces converge towards the second inner sleeve end, that the locking jaws between which the spreading projection is received each comprise a second wedge surface on their sides facing each other in the circumferential direction, wherein the second wedge surfaces converge towards the second inner sleeve end, and that the first wedge surfaces are configured to interact with the second wedge surfaces during the movement of the outer sleeve from the initial position into the release position in order to spread the locking jaws from the standby position into a release position in which the locking of the first fluid line, in particular the reception in a form-fitting manner in the circumferential grooves, is completely releasable. In particular, if there are more than two locking jaws, it may be advantageous to combine spreading projections and snap-in sections with wedge surfaces.

Preferably, the plug-in connector comprises at least one spring element which is configured to apply an actuating force on the outer sleeve in the initial position, which force is directed towards the first inner sleeve end. The spring element may, for example, comprise a coil spring which surrounds the inner sleeve, preferably in the region of the second jaw ends of the locking jaws. This facilitates handling because the locking mechanism is essentially automatically releasable.

Preferably, the second connecting section of the inner sleeve has a sealing arrangement that is configured to create a seal between the first fluid line and the second fluid line. The sealing arrangement may, for example, comprise at least two sealing rings and a spacer element arranged between the sealing rings, wherein an inner circumferential surface of the sealing rings is configured to abut against an outer circumferential surface of an end section of the first fluid line and an outer circumferential surface of the sealing rings is configured to abut against an inner circumferential surface of an end section of the second fluid line. This allows a direct seal to be created between the first fluid line and the second fluid line, meaning that no special sealing requirements need to be imposed on the plug-in connector.

The locking jaws may each comprise, on an inner circumferential surface in the region of the first inner sleeve end, preferably in the region of the first jaw ends, an insertion surface which is inclined in the direction of the first inner sleeve end. This facilitates the handling of the plug-in connector when connecting the first fluid line because the locking jaws are automatically spread apart.

It is advantageous that the second connecting section has a plurality of preferably flexible connecting tabs spaced apart from each other in the circumferential direction which connecting tabs surround a receiving space for receiving an end section of the second fluid line, that a locking opening is provided on each of the connecting tabs, which locking opening penetrates the connecting tab in the radial direction and is configured to interact with a corresponding locking projection of the second fluid line for locking the second fluid line to the inner sleeve. Alternatively or additionally, a locking projection may be provided on an inner circumferential surface of each connecting tab, which locking projection is configured to interact with a corresponding locking opening of the second fluid line for locking the second fluid line to the inner sleeve. This enables a simple and form-fitting connection of the second fluid line.

In a further aspect, the invention relates to a plug-in connector assembly comprising a plug-in connector according to the invention and a first fluid line that is connectable to or connected to the first connecting section, and/or a second fluid line that is connectable or is connected to the second connecting section, wherein the first fluid line has a retaining section on an outer side for locking the first fluid line to the inner sleeve of the plug-in connector. Preferably, the plug-in connector comprises circumferential grooves on the locking jaws, and the retaining section of the first fluid line preferably has a circumferential bead that is receivable in a form-fitting manner in the circumferential grooves of the locking jaws of the inner sleeve.

The plug-in connector is preferably used by inserting a first fluid line, which comprises a retaining section on an outer side, into the open first inner sleeve end of the inner sleeve, so that the actuating projection of the at least one snap-in element is displaced by the retaining section in a radial direction outwards when the first fluid line is inserted, so that the snap-in projections of the snap-in element are released from the second stop projections of the actuating sections of the locking jaws of the inner sleeve and so that the outer sleeve is moved from the initial position to the interlocking position, preferably by the actuating force of the spring element, until the snap-in end faces of the snap-in projections of the snap-in elements abut against the first stop end faces of the first stop projections of the actuating sections of the locking jaws and the first jaw ends of the locking jaws are each in the locked position and the retaining section of the first fluid line is locked to the inner sleeve, wherein preferably a plug-in connector according to the claim is used and the retaining section preferably has a circumferential bead which is received in a form-fitting manner in the circumferential grooves of the locking jaws of the inner sleeve.

Preferably, the outer sleeve is moved relative to the inner sleeve from the interlocking position via the initial position into the release position, wherein the first wedge surfaces of the first snap-in section of the at least one snap-in element and/or the first wedge surfaces of the at least one spreading projection interact with the second wedge surfaces of the locking jaws, whereby the locking jaws are spread from the standby position into the release position, in which the retaining section of the first fluid line is releasable from the inner sleeve.

For a better understanding of the invention, it is explained in more detail with reference to the following figures.

Each of the following figures shows a highly simplified, schematic representation:

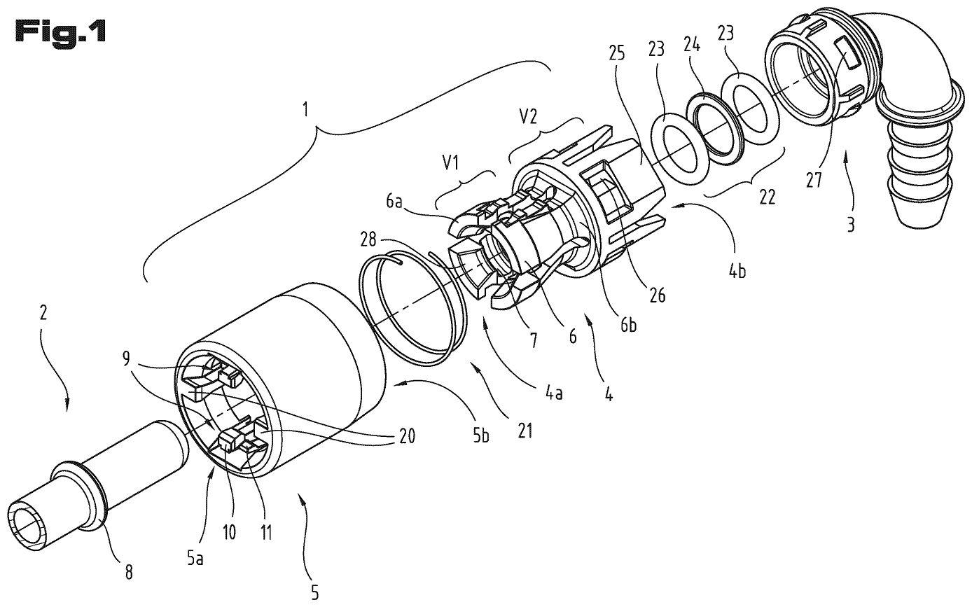

FIG. 1 a perspective exploded view of a plug-in connector assembly with a plug-in connector of an exemplary embodiment of the invention;

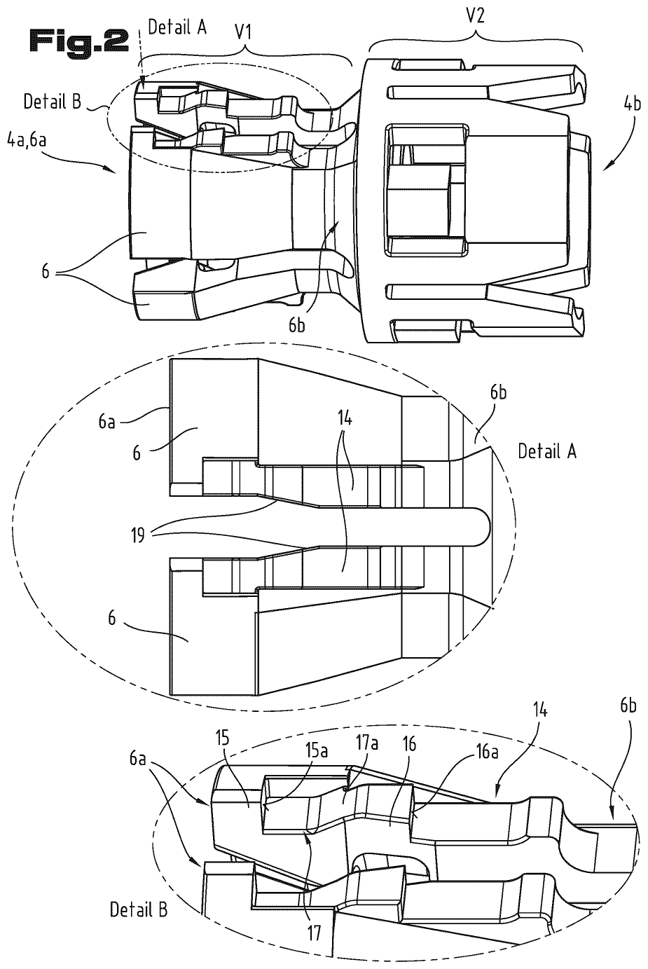

FIG. 2 the inner sleeve of the plug-in connector in a perspective view and two detailed views;

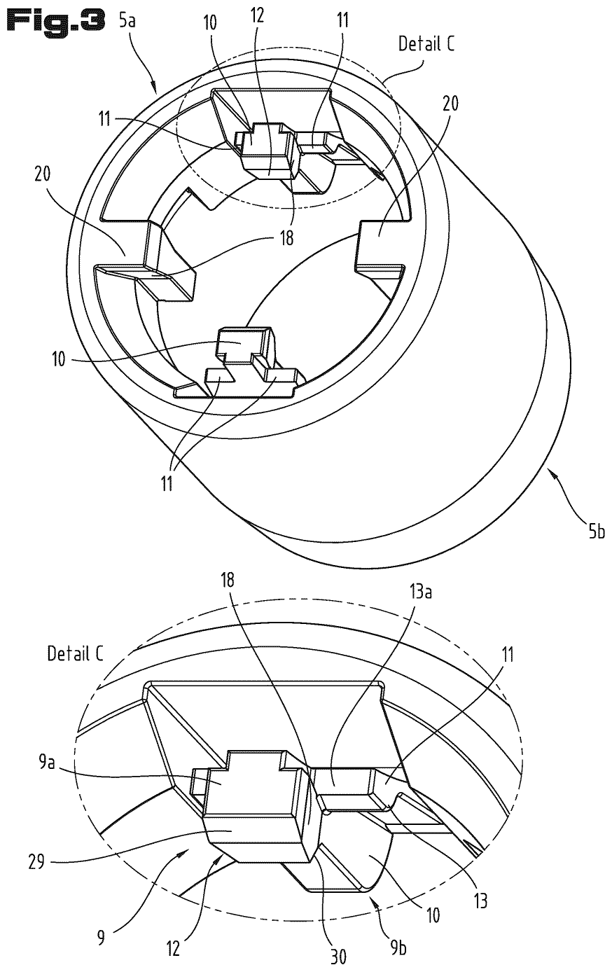

FIG. 3 the outer sleeve of the plug-in connector in a perspective view and a detailed view;

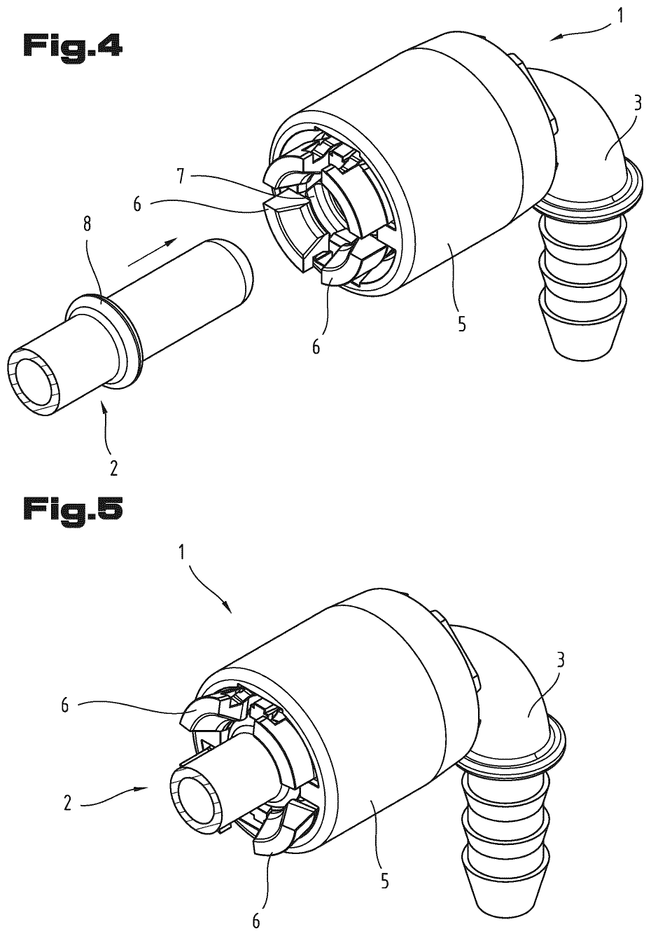

FIG. 4 the plug-in connector assembly in a perspective view, with the outer sleeve of the plug-in connector in the initial position;

FIG. 5 the plug-in connector assembly in a perspective view, wherein the outer sleeve of the plug-in connector is between the initial position and the interlocking position;

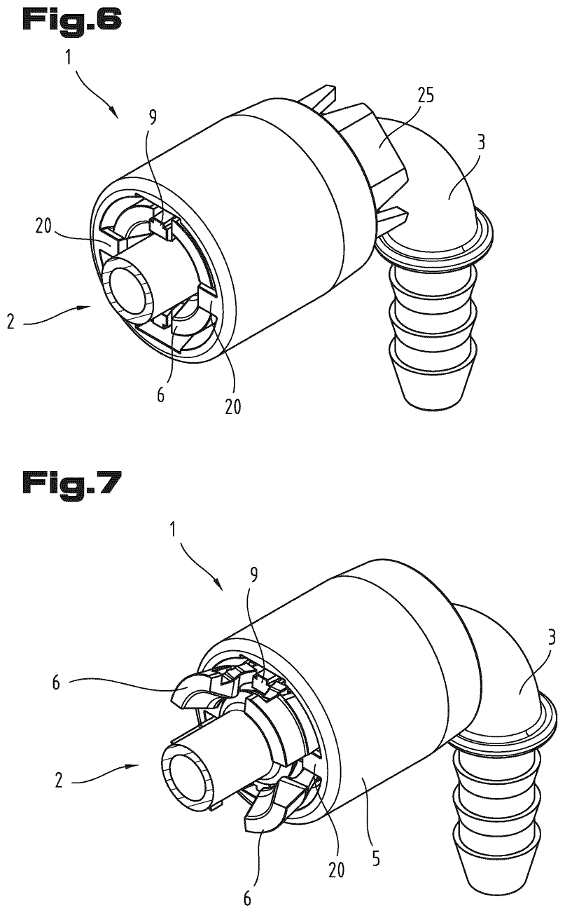

FIG. 6 the plug-in connector assembly in a perspective view, with the outer sleeve of the plug-in connector in the interlocking position;

FIG. 7 the plug-in connector assembly in a perspective view, wherein the outer sleeve of the plug-in connector is in the release position;

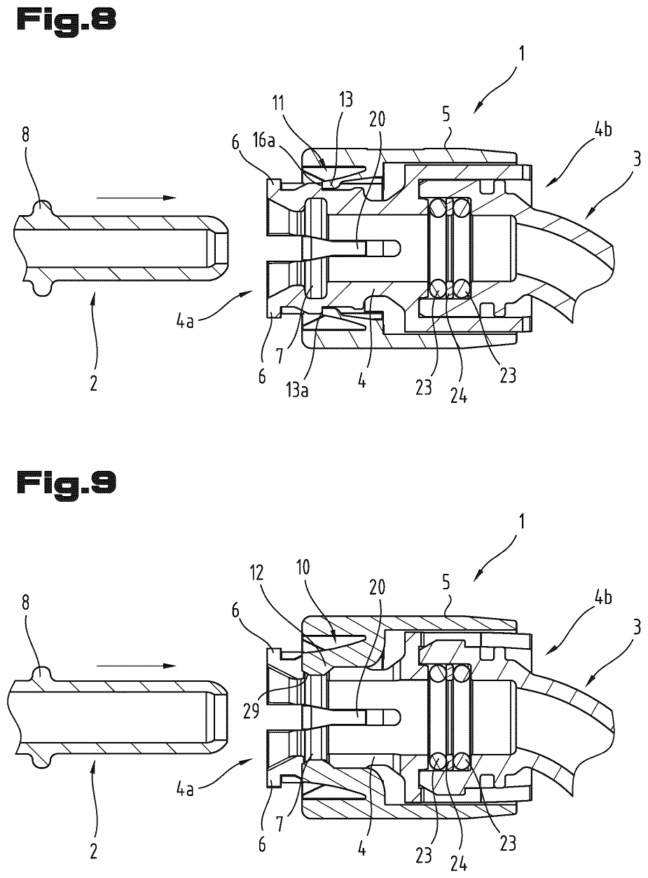

FIG. 8 a longitudinal section through the plug-in connector assembly in the region of a second snap-in section, wherein the outer sleeve of the plug-in connector is in the initial position;

FIG. 9 a longitudinal section through the plug-in connector assembly in the region of a first snap-in section, with the outer sleeve of the plug-in connector in the initial position;

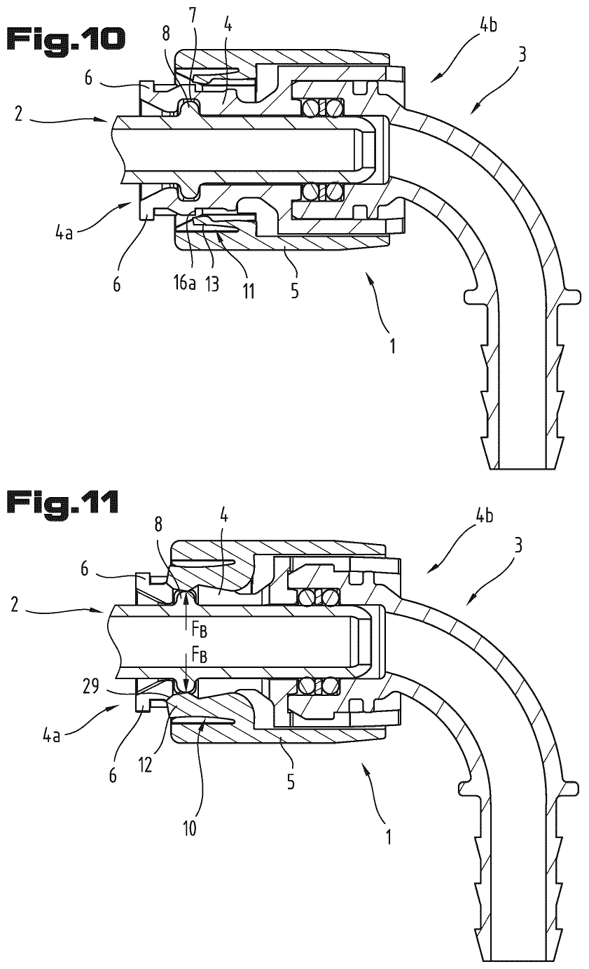

FIG. 10 a longitudinal section through the plug-in connector assembly in the region of a second snap-in section, wherein the outer sleeve of the plug-in connector is in a first position between the initial position and the interlocking position;

FIG. 11 a longitudinal section through the plug-in connector assembly in the region of a first snap-in section, wherein the outer sleeve of the plug-in connector is in the first position between the initial position and the interlocking position;

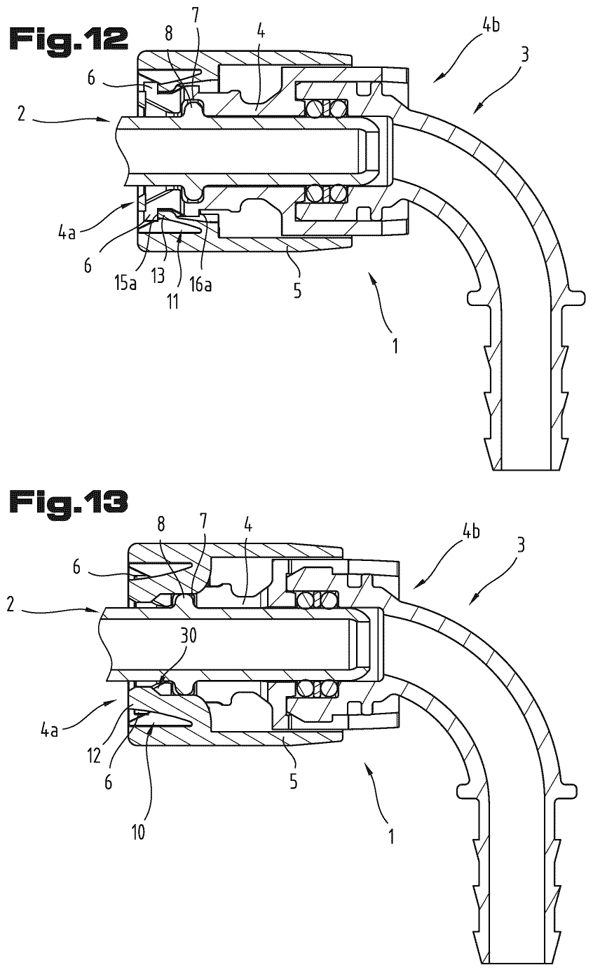

FIG. 12 a longitudinal section through the plug-in connector assembly in the region of a second snap-in section, wherein the outer sleeve of the plug-in connector is in the interlocking position;

FIG. 13 a longitudinal section through the plug-in connector assembly in the region of a first snap-in section, wherein the outer sleeve of the plug-in connector is in the interlocking position;

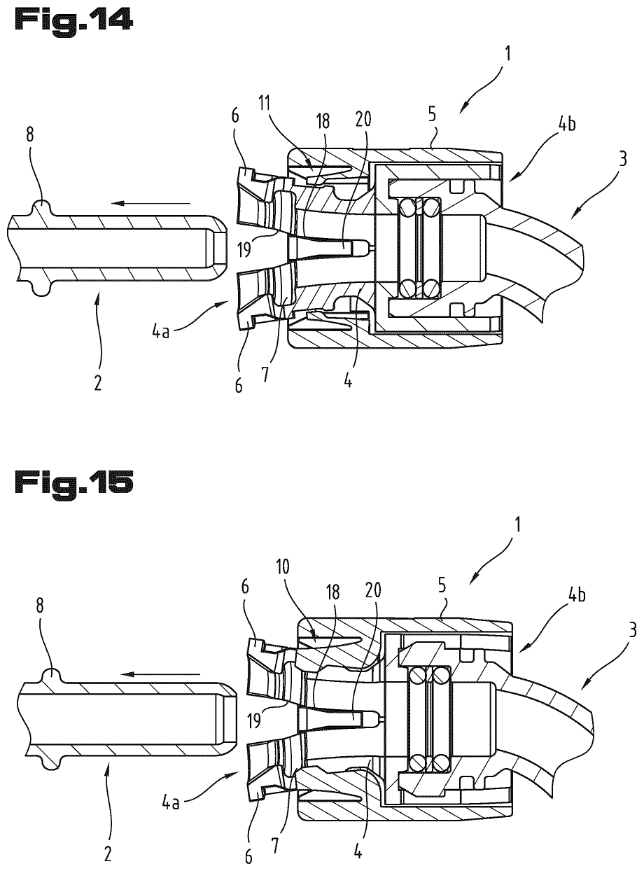

FIG. 14 a longitudinal section through the plug-in connector assembly in the region of a second snap-in section, wherein the outer sleeve of the plug-in connector is in the release position;

FIG. 15 a longitudinal section through the plug-in connector assembly in the region of a first snap-in section, wherein the outer sleeve of the plug-in connector is in the release position.

Firstly, it should be noted that identical parts in the various embodiments described are assigned the same reference signs or the same component designations, whereby the disclosures contained in the entire description may be applied mutatis mutandis to identical parts with the same reference signs or the same component designations. The positional information chosen in the description, such as above, below, side, etc., also refers to the figure directly described and depicted, and this positional information may be transferred to the new position mutatis mutandis in the event of a change in position.

FIG. 1 shows a plug-in connector assembly of an exemplary embodiment in a perspective exploded view. The plug-in connector assembly comprises a plug-in connector 1 in an advantageous embodiment of the invention, as well as a first fluid line 2 and a second fluid line 3. The plug-in connector 1 is configured to connect the first fluid line 2 to the second fluid line 3.

The plug-in connector 1 comprises an inner sleeve 4 with an open first inner sleeve end 4a and an open second inner sleeve end 4b connected to the first inner sleeve end. The inner sleeve 4 is shown here as an example being formed in a straight manner. However, the inner sleeve 4 could of course also be curved or angled.

The plug-in connector 1 further comprises an outer sleeve 5 surrounding the inner sleeve 4, which outer sleeve 5 is movable relative to the inner sleeve 4 at least between an initial position and an interlocking position. In the example shown, the outer sleeve 5 is movable in a longitudinal direction along the inner sleeve 4 between the initial position and the interlocking position. The outer sleeve 5 comprises a first outer sleeve end 5a and an opposite second outer sleeve end 5b, as shown in FIG. 1.

The inner sleeve 4 comprises a first connecting section V1 in the region of the first inner sleeve end 4 a for connecting the first fluid line 2. In the region of the second inner sleeve end 4b, the inner sleeve 4 comprises a second connecting section V2 for connecting the second fluid line 3.

In the example shown, the second connecting section V2 comprises a plurality of connecting tabs 25 that are spaced apart from each other in the circumferential direction. The connecting tabs 25 are preferably flexible so that they may be bent outwards in the radial direction. The connecting tabs 25 surround a receiving space for receiving an end section of the second fluid line 3.

A locking opening 26 is provided on each of the connecting tabs 25, which locking opening 26 penetrates the respective connecting tab 25 in the radial direction. The locking openings 26 are configured to interact with corresponding snap-in projections 27 on the second fluid line 3 for locking the second fluid line 3 to the inner sleeve 4. For connection, the second fluid line 3 may be inserted into the receiving space until the snap-in projections 27 lock to the locking openings 26.

Alternatively or additionally, a locking projection could also be provided on the inner circumferential surface of each of the connecting tabs 25, which locking projection is configured to interact with a corresponding locking opening on the second fluid line 3 for locking the second fluid line 3 to the inner sleeve 4. Of course, the specific embodiment of the second connecting section V2 is only to be understood as an example, and a person skilled in the art could also provide another suitable embodiment.

The connecting tabs 25 may preferably be used to signal to a user whether the outer sleeve 5 is in the interlocking position. In the embodiment shown, this may be seen from the fact that, in the interlocking position, the connecting tabs 25 protrude from the outer sleeve 5 in the axial direction in such a way that the outer circumferential surfaces of the connecting tabs 25 are exposed (see FIG. 6+FIG. 12). Optionally, a machine-readable code, e.g., a QR code, may also be provided on the connecting tabs 25 in order to be able to automatically detect the interlocking position, e.g., by means of a suitable reader.

The second connecting section V2 of the inner sleeve 4 may also comprise a sealing arrangement 22 which is configured to create a seal between the first fluid line 2 and the second fluid line 3. The sealing arrangement comprises two sealing rings 23 and a spacer element 24 which is arranged between the sealing rings 23 in the axial direction of the inner sleeve 4. An inner circumferential surface of the sealing rings 23 is configured to abut against an outer circumferential surface of an end section of the first fluid line 2. An outer circumferential surface of the sealing rings 23 is configured to abut against an inner circumferential surface of an end section of the second fluid line 3, as may be seen, for example, in FIG. 8+FIG. 9.

In the embodiment shown, the first connecting section V1 comprises, for example, four locking jaws 6. However, within the scope of the invention, it would generally be sufficient if at least two locking jaws 6 are provided. Three or more than four locking jaws 6 could also be provided. The locking jaws 6 are arranged spaced apart from each other in the circumferential direction so that an interstitial space is formed between each two adjacent locking jaws 6. The interstitial space is dimensioned such that it may receive a first snap-in section 10 of a snap-in element 9 of the outer sleeve 5, which will be described in more detail below, and, if necessary, a spreading projection 20, which will also be described in more detail below. The locking jaws 6 each have a free first jaw end 6a, against which the first inner sleeve end 4a abuts, and an opposite second jaw end 6b, which is connected to the inner sleeve 4.

In the embodiment shown, the locking jaws 6 each have a circumferential groove 7 on an inner circumferential surface. The circumferential grooves 7 are shown in FIG. 1. The circumferential grooves 7 are arranged in the axial direction between the first jaw end 6a and the second jaw end 6a. The circumferential grooves 7 are configured to receive a retaining section 8 of the first fluid line 2 in a form-fitting manner when the locking jaws 6 are in the locked position. As may be seen in FIG. 1, the retaining section 8 of the first fluid line 2 is advantageously formed as a circumferential bead which preferably extends around the entire circumference. The position and dimensions of the circumferential grooves 7 and the dimensions of the first fluid line 2, in particular the position and dimensions of the circumferential bead, are preferably matched to each other.

The plug-in connector 1 preferably also comprises a spring element 21 which is configured to apply an actuating force on the outer sleeve 5 in the initial position of the outer sleeve 5, which force is directed towards the first outer sleeve end 5a or the first inner sleeve end 4a. The outer sleeve 5 is thus preloaded in the initial position and may preferably be moved automatically from the initial position into the interlocking position by the spring force when the first fluid line 2 is connected. In the example shown, the spring element 21 comprises, for example, a coil spring which surrounds the inner sleeve 4 in the assembled state in the region of the second jaw ends 6b of the locking jaws 6. Of course, a person skilled in the art could also choose another suitable design.

In order to facilitate the insertion of the first fluid line 2 into the first inner sleeve end 4a of the inner sleeve 4, the locking jaws 6 may each comprise an insertion surface 28 on an inner circumferential surface in the region of the first inner sleeve end 4a, which insertion surface 28 is inclined in the direction of the first inner sleeve end 4a. The insertion surface 28 is shown in FIG. 1.

FIG. 2 shows the inner sleeve 4 in a perspective view as well as two detailed views, Detail A and Detail B. The first jaw ends 6a may be moved in a radial direction relative to the respective second jaw ends 6b between the standby position and the locked position. The inner sleeve 4 may be made of plastic, whereby the locking jaws 6 may be formed integrally with the inner sleeve 4. The first jaw ends 6a may thus be advantageously bent elastically between the locked position and the standby position.

The locking jaws 6 each have an actuating section 14 on their outer circumferential surfaces. The actuating sections 14 may be seen in detail A and, in particular, in detail B in FIG. 2. The actuating sections 14 are arranged in the region of the ends of the locking jaws 6 facing each other in the circumferential direction (between which the interstitial space is formed). The actuating sections 14 extend along the respective locking jaw 6 between the first jaw end 6a and the second jaw end 6b.

The actuating sections 14 each have a first stop projection 15 with a first stop end face 15a and a second stop projection 16 with a second stop end face 16a. The first stop end face 15a and the second stop end face 16a face the second inner sleeve end 4b. The first stop end face 15a is closer to the first inner sleeve end 4a or first jaw end 6a than the second stop end face 16a. The actuating sections 14 serve to interact with second snap-in sections 11 of a snap-in element 9 of the outer sleeve 5, which will be described in more detail below. The exact function will be described in detail below.

In the example shown, the actuating sections 14 of the locking jaws 6 each comprise a sliding surface 17 which connects the first stop end face 15a to the second stop end face 16a. The sliding surface 17 comprises a restraining surface 17a inclined in the direction of the first jaw end 6a, as may be seen in detail B. The function of the restraining surface will be described in more detail below.

FIG. 3 shows the outer sleeve 5 in a perspective view and, in detail C, a detailed view of a snap-in element 9. In the embodiment shown, the outer sleeve 5 comprises two snap-in elements 9, which are arranged diametrically opposite each other. If the inner sleeve comprises only two locking jaws 6, then it would generally be sufficient to provide only one snap-in element 9 on the outer sleeve 5.

The snap-in elements 9 each have a first snap-in section 10, which is received in the circumferential direction between two adjacent locking jaws 6 of the inner sleeve 4 (see, for example, FIG. 6), and two second snap-in sections 11 which are connected to the first snap-in section 10. Here, the snap-in elements 9 are arranged on an inner circumferential surface of the outer sleeve 5. The snap-in elements 9 each have a free first snap-in element end 9a, which, in the assembled state, faces the first outer sleeve end 5a or the first inner sleeve end 4a, and an opposite second snap-in element end 9b, which is connected to the inner circumferential surface of the outer sleeve 5.

The first snap-in element end 9a is movable in the radial direction relative to the second snap-in element end 9b. The outer sleeve 5 is preferably made of a suitable plastic, whereby the snap-in elements 9 may be formed integrally with the outer sleeve 5. In this case, the first snap-in element ends 9a may be bent elastically relative to the respective second snap-in element end 9b.

The first snap-in section 10 comprises an actuating projection 12 that is directed radially inward. The second snap-in sections 11 each have a snap-in projection 13 that is directed inward in the radial direction and comprises a snap-in end face 13a facing the first outer sleeve end 5a. In the assembled state, the snap-in end face 13a also faces the first inner sleeve end 4a.

As may be seen in FIG. 3, the first snap-in section 10 may be arranged centrally between the two second snap-in sections 11 in the circumferential direction and may comprise the first snap-in element end 9a. The actuating projection 12 is arranged on the first snap-in section 10 in the region of the first snap-in element end 9a. The snap-in projections 13 of the second snap-in sections 11 are arranged in the longitudinal direction between the actuating projection 12 and the second snap-in element end 9b. The second snap-in sections 11 are formed integrally with the first snap-in section 10 located between them.

The actuating projection 12 may comprise a first actuating chamfer 29 at the first snap-in element end 9a, which is configured to interact with the retaining section 8 of the first fluid line 2 to displace the actuating projection 12 when the first fluid line 2 is inserted into the first inner sleeve end 4a. The actuating projection 12 may also comprise a second actuating chamfer 30 on a side facing the second snap-in element end 9b, which actuating chamfer 30 is configured to interact with the retaining section 8 of the first fluid line 2 to displace the actuating projection 12 when the first fluid line 2 is removed from the first inner sleeve end 4a. The function of the actuating chamfers 29, 30 is described in more detail below.

In the example shown, the first snap-in sections 10 of the snap-in elements 9 comprise first wedge surfaces 18 on their circumferentially opposite sides, which wedge surfaces 18 converge towards the second outer sleeve end 5b or, in the assembled state, towards the second inner sleeve end 4b. One of the two first wedge surfaces may be seen in Detail C in FIG. 3.

In the example shown, the locking jaws 6 of the inner sleeve 4 comprise second wedge surfaces 19 on their side surfaces facing each other in the circumferential direction (between which the space for receiving the first snap-in section 10 of the snap-in element 9 of the outer sleeve 5 is formed). The second wedge surfaces 19 converge towards the second inner sleeve end 4b or the second jaw ends 6b, as may be seen in Detail A in FIG. 2.

The first wedge surfaces 18 of the snap-in elements 9 are configured to interact with the corresponding second wedge surfaces 19 of the locking jaws 6 when the outer sleeve 5 is moved, in order to spread the locking jaws 6 radially. This function is described in detail below with reference to FIG. 14+FIG. 15.

In the example shown, two spreading projections 20 are also provided on an inner circumferential surface of the outer sleeve 5. Here, the spreading projections 20 are arranged diametrically opposite each other. The spreading projections 20 are spaced apart from the snap-in elements 9 at an angle of 90° in the circumferential direction, as may be seen in FIG. 3. Analogous to the first snap-in sections 10 of the snap-in elements 9, the spreading projections 20 also have first wedge surfaces 18 on their sides opposite each other in the circumferential direction which wedge surfaces 18 converge towards the second outer sleeve end 5b or, in the assembled state, towards the second inner sleeve end 4b, as may be seen in FIG. 14+FIG. 15.

The locking jaws 6 of the inner sleeve 4 comprise second wedge surfaces 19 on their side surfaces facing each other in the circumferential direction (between which the space for receiving the spreading projections 20 of the outer sleeve 5 is formed). The second wedge surfaces 19 converge towards the second inner sleeve end 4b or the second jaw ends 6b, as may also be seen in FIG. 14.

The first wedge surfaces 18 of the spreading projections 20 are configured to interact with the corresponding second wedge surfaces 19 of the locking jaws 6 when the outer sleeve 5 is moved in order to spread the locking jaws 6. The function is described in detail below. The function of the plug-in connector 1 is described in more detail below with reference to FIGS. 4 to 15.

FIG. 4 shows the plug-in connector assembly in a perspective view. The second fluid line 3 is connected to the second connecting section V2 (see FIG. 1) of the plug-in connector 1, and the first fluid line 1 is in a state prior to being connected to the plug-in connector 1. The outer sleeve 5 of the plug-in connector 1 is in the initial position. FIG. 8 +FIG. 9 each show a longitudinal section through the plug-in connector assembly from FIG. 4, wherein the section plane in FIG. 8 lies in the region of the second snap-in sections 11 of the snap-in elements 9 and in FIG. 9 lies in the region of the first snap-in sections 10 of the snap-in elements 9.

The locking jaws 6 of the inner sleeve 4 are in the initial position of the outer sleeve 5 in the standby position, in which the first fluid line 2 may be inserted through the first inner sleeve end 4a, as indicated by the corresponding arrow in FIG. 4. As may be seen in FIG. 9, the actuating projections 12 of the first snap-in sections 10 of the snap-in elements 9 are in a position in which they may be actuated by the retaining section 8, in particular the circumferential bead, of the first fluid line 2.

As may be seen in FIG. 8, the snap-in end faces 13a of the snap-in projections 13 of the second snap-in sections 11 of the snap-in elements 9 of the outer sleeve 5 abut against the corresponding second stop end faces 16a of the second stop projections 16 of the actuating sections 14 of the locking jaws 6 of the inner sleeve 4. The outer sleeve 5 is thus fixed in the initial position. In the initial position, the first inner sleeve end 4a of the inner sleeve 4 preferably protrudes beyond the first outer sleeve end 5a of the outer sleeve 5.

FIG. 5 shows the plug-in connector assembly in a perspective view. The second fluid line 3 is in turn connected to the second connecting section V2 of the plug-in connector 1, and the first fluid line 1 is in a position during the connection process with the first connecting section V1 of the plug-in connector 1. The outer sleeve 5 of the plug-in connector 1 is in a position between the initial position and the interlocking position. FIG. 10 +FIG. 11 each show a longitudinal section through the plug-in connector assembly from FIG. 5, wherein the section plane in FIG. 10 is in turn in the region of the second snap-in sections 11 of the snap-in elements 9 and in FIG. 11 is in the region of the first snap-in sections 10 of the snap-in elements 9.

As may be seen in FIG. 11, when the first fluid line 2 is inserted into the first inner sleeve end 4a, an actuating force FB may be applied in a radial direction outwardly on the actuating projections 12 of the first snap-in sections 10 of the snap-in elements 9 by the retaining section 8, in particular the circumferential bead. Because the second snap-in sections 11 are connected to the first snap-in section 10, the snap-in projections 13 may be released from the second stop projections 16 by the actuating force FB. This allows the outer sleeve 5 to be released from the inner sleeve 4 and moved from the initial position into the interlocking position. The movement is preferably supported by the spring element 21 or, if necessary, occurs automatically. The outward displacement of the snap-in elements 9 may be facilitated by the first actuating chamfers 29 on the actuating projections 12.

FIG. 6 shows the plug-in connector assembly in a perspective view. The second fluid line 3 is again connected to the second connecting section V2 of the plug-in connector 1, and the first fluid line 1 is connected to the first connecting section V1 (see FIG. 1) of the plug-in connector 1. The outer sleeve 5 of the plug-in connector 1 is accordingly in the interlocking position. FIG. 12+FIG. 13 each show a longitudinal section through the plug-in connector assembly from FIG. 6, wherein the section plane in FIG. 12 lies in the region of the second snap-in sections 11 of the snap-in elements 9 and in FIG. 13 lies in the region of the first snap-in sections 10 of the snap-in elements 9.

In the interlocking position of the outer sleeve 5, the locking jaws 6 are each in the locked position in which the retaining section 8 of the first fluid line 2 is locked to the inner sleeve 4. In particular, in the example shown, the circumferential bead of the first fluid line 2 is received in a form-fitting manner in the circumferential grooves 7 of the locking jaws 6, as may be seen in FIG. 12. As may also be seen in FIG. 12, the snap-in end faces 13a of the snap-in projections 13 of the second snap-in sections 11 of the snap-in elements 9 abut against the corresponding first stop end faces 15a of the first stop projections 15 of the actuating sections 14 of the locking jaws 6.

To release, the outer sleeve 5 may first be moved back from the interlocking position to the initial position, preferably manually by a user. Undesired movement of the outer sleeve 5 from the interlocking position into the initial position may be prevented on the one hand by the inclined restraining surfaces 17a of the sliding surfaces 17 of the actuating sections 14, since a certain amount of force is required to overcome the restraining surfaces 17a with the snap-in projections 13. In addition, the spring force of the spring element 21 counteracts unwanted releasing of the outer sleeve 5.

When the outer sleeve 5 has been moved back into the initial position, the snap-in projections 13 may lock again with the corresponding second stop end faces 16 a, and the first fluid line 2 may in principle already be pulled out of the inner sleeve 4. The retaining section 8, in particular the circumferential bead, of the first fluid line 2 may interact with the second actuating chamfers 30 on the actuating projections 12 to facilitate the removal of the first fluid line 2.

According to an advantageous embodiment of the invention, however, the outer sleeve 5 is moveable relative to the inner sleeve 4 from the interlocking position via the initial position further into a release position. The release position serves to facilitate the removal of the first fluid line 2 from the first connecting section V1.

FIG. 7 shows the plug-in connector assembly in a perspective view. The second fluid line 3 is connected to the second connecting section V2 of the plug-in connector 1, and the first fluid line 1 is in a state after being released from the plug-in connector 1. The outer sleeve 5 of the plug-in connector 1 is in the release position. FIG. 14+FIG. 15 show a longitudinal section through the plug-in connector assembly from FIG. 7, wherein the section plane in FIG. 14 lies in the region of the second snap-in sections 11 of the snap-in elements 9 and in FIG. 15 lies in the region of the first snap-in sections 10 of the snap-in elements 9.

As already described with reference to FIG. 3, in the embodiment shown, the first snap-in sections 10 of the snap-in elements 9 have first wedge surfaces 18 which converge towards the second outer sleeve end 5b or, in the assembled state, towards the second inner sleeve end 4b. In addition, the locking jaws 6 have second wedge surfaces 19 in the side surfaces (in the interstitial spaces in which the first snap-in sections 10 are received) facing each other in the circumferential direction, which second wedge surfaces 19 converge towards the second outer sleeve end 5b or, in the assembled state, towards the second inner sleeve end 4b. (see FIG. 2).

As already described with reference to FIG. 3, in the embodiment shown, two spreading projections 20 are provided on an inner circumferential surface of the outer sleeve 5. The spreading projections 20 are each received in the circumferential direction in a space between two adjacent locking jaws 6 (namely in those spaces in which no snap-in elements 9 are provided). The spreading projections 20 each have first wedge surfaces 18 on their circumferentially opposite side surfaces, which converge towards the second outer sleeve end 5b or, in the assembled state, towards the second inner sleeve end 4b, as may also be seen in FIG. 14+FIG. 15.

In addition, the locking jaws 6 have second wedge surfaces 19 on their side surfaces (in the corresponding interstitial spaces in which the spreading projections 20 are received) facing each other in the circumferential direction, which second wedge surfaces 19 converge towards the second outer sleeve end 5b or, in the assembled state, towards the second inner sleeve end 4b (see FIG. 2 and FIG. 14 +FIG. 15).

When the outer sleeve 5 is moved from the initial position (shown in FIG. 4 and FIG. 8+FIG. 9) further into the release position (shown in FIG. 7 and FIG. 14+FIG. 15), the first wedge surfaces 18 of the snap-in elements 9 and the first wedge surfaces 18 of the spreading projections 20 interact with the respective second wedge surfaces 19 of the locking jaws 6 to spread the locking jaws 6 from the standby position into a release position. The release position may be seen in FIG. 7 and in FIG. 14+FIG. 15. In the release position, the locking jaws 6 are spread apart in the radial direction to such an extent that the locking of the retaining section 8 of the first fluid line 2 on the inner sleeve 4, in particular the reception in a form-fitting manner of the circumferential bead in the circumferential grooves 7, is completely released. The first fluid line 2 may thus be easily released from the plug-in connector 1, as indicated by the arrows in FIG. 14+FIG. 15.

After releasing the first fluid line 2, the outer sleeve 5 may be moved back to its initial position, preferably again supported by the release spring 21. In the initial position, the components of the plug-in connector 1 are preferably in a stress-relieved state so that material fatigue, in particular relaxation of the plastic, may be avoided.

The exemplary embodiments show possible design variants, whereby it should be noted at this point that the invention is not limited to the specifically illustrated design variants thereof, but rather that various combinations of the individual design variants are also possible, and that this possibility of variation is within the skill of a person skilled in the art based on the teaching of the technical action of the present invention.

The scope of protection is determined by the claims. However, the description and drawings are to be used to interpret the claims. Individual features or combinations of features from the various embodiments shown and described may represent independent inventive solutions. The object underlying the independent inventive solutions may be found in the description.

All information on value ranges in the present description is to be understood as including any and all sub-ranges thereof, e.g., the specification 1 to 10 is to be understood as including all sub-ranges, starting from the lower limit of 1 and the upper limit of 10, i.e., all sub-ranges start with a lower limit of 1 or greater and end with an upper limit of 10 or less, e.g., 1 to 1.7, or 3.2 to 8.1, or 5.5 to 10.

For the sake of clarity, it should be noted that, for a better understanding of the structure, some elements have been shown out of scale and/or enlarged and/or reduced in size.

### REFERENCE SIGNS

1 plug-in connector
2 first fluid line
3 second fluid line
4 inner sleeve
4a first inner sleeve end
4b second inner sleeve end
5 outer sleeve
5a first outer sleeve end
5b second outer sleeve end
6 locking jaws
7 circumferential groove
8 retaining section
9 snap-in element
9a first snap-in element end
9b second snap-in element end
10 first snap-in section
11 second snap-in section
12 actuating projection
13 snap-in projection
13a snap-in front surface
14 actuating section
15 first stop projection
15a first stop end face
16 second stop projection
16a second stop end face
17 sliding surface
17a restraining surface
18 first wedge surface
19 second wedge surface
20 spreading projection
21 spring element
22 sealing arrangement
23 sealing ring
24 spacer element
25 connecting tab
26 locking opening
27 locking projection
28 insertion surface
29 first actuating chamfer
30 second actuating chamfer
V1 first connecting section
V2 second connecting section
FB actuating force

1: A plug-in connector (1) for connecting a first fluid line (2) to a second fluid line (3), wherein the plug-in connector (1) comprises an inner sleeve (4) with an open first inner sleeve end (4a) and an open second inner sleeve end (4b) connected to the first inner sleeve end, and comprises an outer sleeve (5) surrounding the inner sleeve (4), wherein the outer sleeve (5) is movable relative to the inner sleeve (4) between an initial position and an interlocking position, wherein the inner sleeve (4) comprises a first connecting section (V1), in the region of the first inner sleeve end (4a), for connecting the first fluid line (2) and comprises a second connecting section (V2), in the region of the second inner sleeve end (4b), for connecting the second fluid line (3), wherein the first connecting section (V1) comprises at least two locking jaws (6) spaced apart from each other in the circumferential direction, wherein the locking jaws (6) are located in the initial position of the outer sleeve (5) in a standby position in which the first fluid line (2) is insertable into the first inner sleeve end (4a), and which are located in the interlocking position of the outer sleeve (5) in a locked position in which a retaining section (8) of the first fluid line (2) is lockable to the inner sleeve (4), wherein the outer sleeve (5) comprises at least one snap-in element (9) which has a first snap-in section (10) which is received in the circumferential direction between two adjacent locking jaws (6) of the inner sleeve (4) and has two second snap-in sections (11) connected to the first snap-in section (10), wherein the first snap-in section (10) comprises an actuating projection (12) and the second snap-in sections (11) each comprise a snap-in projection (13) with a snap-in end face (13a) facing the first inner sleeve end (4a), wherein the locking jaws (6) each have at least one actuating section (14) on an outer circumferential surface, wherein the actuating section (14) comprises a first stop projection (15) with a first stop end face (15a) and a second stop projection (16) with a second stop end face (16a), wherein the snap-in end faces (13a) of the snap-in projections (13) abut against the second stop end faces (16a) of the second stop projections (16) in the initial position of the outer sleeve (5), and wherein the actuating projection (12) is displaceable radially outwards by the retaining section (8) when the first fluid line (2) is inserted into the first inner sleeve end (4a), so that the snap-in projections (13) are releasable from the second stop projections (16) and the outer sleeve (5) is moveable from the initial position into the interlocking position, in which the snap-in end faces (13a) of the snap-in projections (13) abut against the first stop end faces (15a) of the first stop projections (15).

2: The plug-in connector (1) according to claim 1, wherein the outer sleeve (5) is moveable in a longitudinal direction along the inner sleeve (4) between the initial position and the interlocking position and/or wherein, in the initial position of the outer sleeve (5), the first inner sleeve end (4a) of the inner sleeve (4) protrudes beyond a first outer sleeve end (5a) of the outer sleeve (5).

3: The plug-in connector (1) according to claim 1, wherein the locking jaws (6) each have a free first jaw end (6a) against which the first inner sleeve end (4a) abuts, and an opposite second jaw end (6b) which is connected to the inner sleeve (4), wherein the first jaw ends (6a) are movable in a radial direction relative to the second jaw ends (6b) between the standby position and the locked position, wherein the locking jaws (6) each have a circumferential groove (7) on an inner circumferential surface, which is arranged between the first jaw end (6a) and the second jaw end (6a), wherein the circumferential grooves (7) are configured to receive the retaining section (8) of the first fluid line (2) in a form-fitting manner in the locked position of the locking jaws (6).

4: The plug-in connector (1) according to claim 1, wherein the at least one snap-in element (9) is arranged on an inner circumferential surface of the outer sleeve (5) and has a free first snap-in element end (9a) facing the first inner sleeve end (4a), and has an opposite second snap-in element end (9b) connected to the inner circumferential surface of the outer sleeve (5), wherein the first snap-in element end (9a) is movable relative to the second snap-in element end (9b) in the radial direction.

5: The plug-in connector (1) according to claim 4, wherein the actuating projection (12) on the first snap-in element end (9a) comprises a first actuating chamfer (29) which is configured to interact with the retaining section (8) of the first fluid line (2) to displace the actuating projection (12) when the first fluid line (2) is inserted into the first inner sleeve end (4a), and/or wherein the actuating projection (12) comprises a second actuating chamfer (30) on a side facing the second snap-in element end (9b), wherein the second actuating chamfer (30) is configured to interact with the retaining section (8) of the first fluid line (2) when the first fluid line (2) is removed from the first inner sleeve end (4a) to displace the actuating projection (12).

6: The plug-in connector (1) according to claim 1, wherein the first snap-in section (10) is arranged centrally between the two second snap-in sections (11) in the circumferential direction and comprises the first snap-in element end (9a), wherein the actuating projection (12) is provided on the first snap-in section (10) in the region of the first snap-in element end (9a) and wherein the snap-in projections (13) of the second snap-in sections (11) are each arranged in the longitudinal direction between the actuating projection (12) and the second snap-in element end (9b).

7: The plug-in connector (1) according to claim 1, wherein at least three, preferably at least four locking jaws (6) are provided and/or wherein at least two snap-in elements (9) are provided.

8: The plug-in connector (1) according to claim 1, wherein the actuating sections (14) of the locking jaws (6) each comprise a sliding surface (17) which connects the first stop end face (15a) to the second stop end face (16a), wherein the sliding surface (17) comprises a restraining surface (17a) inclined in the direction of the first jaw end (6a).

9: The plug-in connector (1) according to claim 1, wherein the inner sleeve (4) is made of plastic, wherein the locking jaws (6) are formed integrally with the inner sleeve (4) and wherein the first jaw ends (6a) are elastically bendable between the locked position and the standby position and/or wherein the outer sleeve (5) is made of plastic, wherein the at least one snap-in element (9) is integrally formed with the outer sleeve (5) and wherein the first snap-in element end (9a) is elastically bendable in the radial direction relative to the second snap-in element end (9b).

10: The plug-in connector (1) according to one of claim 1, wherein the outer sleeve (5) is movable relative to the inner sleeve (4) from the interlocking position via the initial position into a release position, wherein the first snap-in section (10) of the at least one snap-in element (9) comprises a first wedge surface (18) on each of its sides opposite each other in the circumferential direction, wherein the first wedge surfaces (18) converge towards the second inner sleeve end (4b), wherein the locking jaws (6), between which the first snap-in section (10) is received, each comprise a second wedge surface (19) on their sides facing each other in the circumferential direction, wherein the second wedge surfaces (19) converge towards the second inner sleeve end (4b), and wherein the first wedge surfaces (18) are configured to interact with the second wedge surfaces (19) during the movement of the outer sleeve (5) from the initial position into the release position in order to spread the locking jaws (6) from the standby position into a release position in which the locking of the first fluid line (2), in particular the reception in a form-fitting manner of the retaining section (8) in the circumferential grooves (7), is completely releasable.

11: The plug-in connector (1) according to one of claim 1, wherein the outer sleeve (5) is movable relative to the inner sleeve (4) from the interlocking position via the initial position into a release position, wherein at least one spreading projection (20) is provided on an inner circumferential surface of the outer sleeve (5), wherein the spreading projection (20) is received between two adjacent locking jaws (6) in the circumferential direction, that wherein the spreading projection (20) comprises a first wedge surface (18) on each of its sides opposite each other in the circumferential direction, wherein the first wedge surfaces (18) converge towards the second inner sleeve end (4b), wherein the locking jaws (6) between which the spreading projection (20) is received each comprise a second wedge surface (19) on their sides facing each other in the circumferential direction, wherein the second wedge surfaces (19) converge towards the second inner sleeve end (4b), and wherein the first wedge surfaces (18) are configured to interact with the second wedge surfaces (19) during the movement of the outer sleeve (5) from the initial position into the release position in order to spread the locking jaws (6) from the standby position into a release position in which the locking of the first fluid line (2), in particular the reception in a form-fitting manner in the circumferential grooves (7), may be completely released.

12: The plug-in connector (1) according to claim 1, wherein the plug-in connector (1) comprises at least one spring element (21) which is configured to apply an actuating force on the outer sleeve (5) in the initial position, wherein the force is directed towards the first inner sleeve end (4a).

13: The plug-in connector (1) according to claim 12, wherein the spring element (21) comprises a coil spring which surrounds the inner sleeve (4), preferably in the region of the second jaw ends (6b) of the locking jaws (6).

14: The plug-in connector (1) according to claim 1, wherein the second connecting section (V2) of the inner sleeve (4) comprises a sealing arrangement (22) which is configured to create a seal between the first fluid line (2) and the second fluid line (3).

15: The plug-in connector (1) according to claim 14, wherein the sealing arrangement comprises at least two sealing rings (23) and comprises a spacer element (24) arranged between the sealing rings (23), wherein an inner circumferential surface of the sealing rings (23) is configured to abut against an outer circumferential surface of an end portion of the first fluid line (2) and an outer circumferential surface of the sealing rings (23) is configured to abut against an inner circumferential surface of an end section of the second fluid line (3).

16: The plug-in connector (1) according to any one claim 1, wherein the locking jaws (6) each comprise, on an inner circumferential surface in the region of the first inner sleeve end (4a), preferably in the region of the first jaw ends (6a), an insertion surface (28) which is inclined in the direction of the first inner sleeve end

17: The plug-in connector (1) according to claim 1, wherein the second connecting section (V2) comprises a plurality of preferably flexible connecting tabs (25) spaced apart from each other in the circumferential direction, wherein the connecting tabs (25) surround a receiving space for receiving an end section of the second fluid line (3), wherein a locking opening (26) is provided on each of the connecting tabs (25), wherein the locking opening (26) penetrates the connecting tab (25) in the radial direction and is configured to interact with a corresponding locking projection (27) of the second fluid line (3) for locking the second fluid line (3) to the inner sleeve (4), and/or wherein a locking projection is provided on an inner circumferential surface of each of the connecting tabs (25), wherein the locking projection is configured to interact with a corresponding locking opening of the second fluid line (3) for locking the second fluid line to the inner sleeve

18: A plug-in connector assembly comprising the plug-in connector (1) according to claim 3 and a first fluid line (2) that is connectable or is connected to the first connecting section (V1), and/or a second fluid line (3) which is connectable or is connected to the second connecting section (V2), wherein the first fluid line (2) comprises a retaining section (8) on an outer side for locking the first fluid line (2) to the inner sleeve (4) of the plug-in connector (1), wherein the retaining section (8) preferably has a circumferential bead which is receivable in a form-fitting manner in the circumferential grooves (7) of the locking jaws (6) of the inner sleeve (4).

19: A method of using the plug-in connector (1) according to claim 3, comprising inserting a first fluid line (2), which comprises a retaining section (8) on an outer side, into the open first inner sleeve end (4a) of the inner sleeve (4), wherein the actuating projection (12) of the at least one snap-in element (9) is displaced by the retaining section (8) in a radial direction outwards when the fluid line (2) is inserted, so that the snap-in projections (13) of the snap-in element (9) are released from the second stop projections (16) of the actuating sections (14) of the locking jaws (6) of the inner sleeve (4), and so that the outer sleeve (5) is moved from the initial position into the interlocking position, preferably by the actuating force of the spring element (21), until the snap-in end faces (13a) of the snap-in projections (13) of the snap-in elements (9) abut against the first stop end faces (15a) of the first stop projections (15) of the actuating sections (14) of the locking jaws (6) and the first jaw ends (6a) of the locking jaws (6) are each in the position and the retaining section (8) of the first fluid line (2) is locked to the inner sleeve (4), wherein the retaining section (8) preferably has a circumferential bead which is received in a form-fitting manner in the circumferential grooves (7) of the locking jaws (6) of the inner sleeve

20: The method according to claim 19, wherein the outer sleeve (5) is moved relative to the inner sleeve (4) from the interlocking position via the initial position into the release position, wherein the first wedge surfaces (18) of the first snap-in section (10) of the at least one snap-in element (9) and/or the first wedge surfaces (18) of the at least one spreading projection (20) interact with the second wedge surfaces (19) of the locking jaws (6), whereby the locking jaws (6) are spread apart from the standby position into the release position, in which the retaining section (8) of the first fluid line (2) is releasable from the inner sleeve (4).
